(19) United States
(12) Patent Application Publication
(10) Pub. No.: US 2025/0342767 A1
(43) Pub. Date: Nov. 6, 2025

(54) OUTPUTTING VERTIPORT CONDITIONS TO AIRCRAFT USING STANDARDIZED MESSAGE PROTOCOLS

(71) Applicant: Wisk Aero LLC, Mountain View, CA (US)

(72) Inventor: Phil Swinsburg, Brisbane (AU)

(73) Assignee: Wisk Aero LLC, Mountain View, CA (US)

(21) Appl. No.: 19/191,392

(22) Filed: Apr. 28, 2025

Related U.S. Application Data
(60) Provisional application No. 63/641,869, filed on May 2, 2024.

(51) Int. Cl. G08G 5/26; G08G 5/70

(52) U.S. Cl. CPC G08G 5/26; G08G 5/70

(57) ABSTRACT

Techniques for outputting landing area conditions to aircraft using standardized message protocols are provided. In an example method, a computing device accesses a configuration for generating messages using a predetermined message format for a first air traffic management device located at a first landing area. The computing device updates the configuration with information about a condition at the first landing area using the predetermined message format. The computing device outputs, using the first air traffic management device, a message based on the configuration, including transmitting the message to a second air traffic management device associated with an aircraft within a predetermined distance of the first landing area.

### CROSS-REFERENCE TO RELATED APPLICATIONS

This application claims benefit under 35 USC§ 119(e) to U.S. Provisional Patent Application No. 63/641,869 filed May 2, 2024, and entitled “OUTPUTTING VERTIPORT CONDITIONS TO AIRCRAFT USING STANDARDIZED MESSAGE PROTOCOLS,” the disclosure of which is incorporated by reference herein in its entirety for all purposes.

### FIELD

The present application generally relates to automated landing hazard avoidance systems, and more particularly relates to techniques for outputting vertiport conditions to aircraft using standardized message protocols.

### BACKGROUND

An in-flight aircraft may be in contact with ground control stations via a command and control (C2) communication link. In some cases, the C2 link may become unavailable during flight operations. For example, the aircraft may enter an area with poor satellite coverage or experience interference from environmental factors, leading to a temporary loss of communication with the ground control station.

### SUMMARY

Various examples of techniques for outputting landing area conditions to aircraft using standardized message protocols are provided. In an example method, a computing device accesses a configuration for generating messages using a predetermined message format for a first air traffic management device located at a first landing area. The computing device updates the configuration with information about a condition at the landing area using the predetermined message format. The computing device outputs, using the first air traffic management device, a message based on the configuration, including transmitting the message to a second air traffic management device associated with an aircraft within a predetermined distance of the landing area.

An example non-transitory computer-readable medium stores instructions that, when executed by one or more processors, cause the one or more processors to perform operations including accessing a configuration for generating messages using a predetermined message format for a first air traffic management device located at a first landing area. The computer-readable medium include further instructions that cause the one or more processors to perform additional operations including updating the configuration with information about a condition at the first landing area using the predetermined message format. The computer-readable medium include further instructions that cause the one or more processors to perform additional operations including outputting, using the first air traffic management device, a message based on the configuration, including transmitting the message to a second air traffic management device associated with an aircraft within a predetermined distance of the first landing area.

An example system includes one or more processors and one or more computer-readable storage media storing instructions which, when executed by the one or more processors, cause the one or more processors to perform operations including accessing a configuration for generating messages using a predetermined message format for a first air traffic management device located at a first landing area. The one or more computer-readable storage media further include additional instructions which cause the one or more processors to perform additional operations including updating the configuration with information about a condition at the first landing area using the predetermined message format. The one or more computer-readable storage media further include additional instructions which cause the one or more processors to perform additional operations including outputting, using the first air traffic management device, a message based on the configuration, including transmitting the message to a second air traffic management device associated with an aircraft within a predetermined distance of the first landing area.

An example system includes a first air traffic management device disposed in an aircraft, the first air traffic management device including a transceiver configured to receive a message from a second air traffic management device located at a first landing area, the message including information about a condition at the first landing area. The system includes a flight control computer disposed in the aircraft and including one or more processors and one or more computer-readable storage media storing instructions which, when executed by the one or more processors, cause the one or more processors to perform operations including receiving the message from the transceiver. The operations include, responsive to the message, diverting the aircraft to a second landing area. The operations include broadcasting the message to one or more other aircraft, wherein each of the other aircraft including an air traffic management device configured to receive the message.

Another example system includes a first air traffic management device located at a first landing area, the first air traffic management device including a transceiver configured to broadcast landing hazard avoidance information to one or more aircraft that intend to land at the first landing area. The system includes a landing hazard avoidance control computer including one or more processors and one or more computer-readable storage media storing instructions which, when executed by the one or more processors, cause the one or more processors to perform operations including accessing a configuration for the first air traffic management device, the configuration based on a predetermined message format. The operations include updating the configuration with information about a landing hazard at the first landing area using the predetermined message format. The operations include transmitting, using the first air traffic management device, a message based on the configuration, to a second air traffic management device disposed within an aircraft within a predetermined distance of the first landing area to cause the aircraft to divert to a second landing area.

### BRIEF DESCRIPTION OF THE DRAWINGS

Various embodiments of the invention are disclosed in the following detailed description and the accompanying drawings.

FIG. 1 is a block diagram of an example system for outputting vertiport conditions to aircraft using standardized message protocols, according to some aspects of the present disclosure.

FIG. 2 is a block diagram of an example system for sending and receiving ADS-B messages, according to some aspects of the present disclosure.

FIG. 3 is a block diagram of an example system including components for an ADS-B network, according to some aspects of the present disclosure.

FIGS. 4A-4D depict a representation of ADS-B message fields that may be used for outputting vertiport conditions to aircraft using standardized message protocols, according to some aspects of the present disclosure.

FIG. 5 is an example of an ADS-B message specification according to some aspects of the present disclosure.

FIG. 6 shows a flowchart of an example method for outputting vertiport conditions to aircraft using standardized message protocols, according to some aspects of the present disclosure.

FIG. 7 shows a flowchart of another example method for outputting vertiport conditions to aircraft using standardized message protocols, according to some aspects of the present disclosure.

FIG. 8 depicts a representation of an ACARS message 800 that may be used for outputting vertiport conditions to aircraft using standardized message protocols, according to some aspects of the present disclosure.

FIG. 9 shows an example computing device suitable for use in example systems or methods for outputting vertiport conditions to aircraft using standardized message protocols, according to some aspects of the present disclosure.

### DETAILED DESCRIPTION

Autonomous aircraft are increasingly entering production as a replacement for crewed aircraft for routine flight operations such as air taxis, cargo delivery, surveillance, environmental monitoring, and so on. Vertical take-off and landing (VTOL) autonomous aircraft are particularly effective in urban or otherwise densely crowded locales in which conventional runways and airport facilities are impractical. For example, VTOL autonomous aircraft can be effective solution for routine short-range transit or commuting, rapid deployment of emergency medical services in crowded cities, or for last-mile delivery of goods in an urban environment.

VTOL autonomous aircraft take off and land at landing areas sometimes referred to as vertiports. A vertiport can include a landing area, platform, or facility equipped to support the autonomous VTOL operations. A vertiport can include facilities for charging or refueling, maintenance, and passenger or cargo handling services, and so on. Vertiports typically are equipped with a suite of communications systems for communication among locations at the vertiport, between vertiports, or between the vertiport and landing or departing aircraft. In some embodiments, a vertiport may occupy considerably less space compared to conventional airports or runways as the VTOL aircraft does not require a runway to takeoff or land.

In general, autonomous aircraft rely upon a number of communication systems for reliable navigation, collision avoidance, weather monitoring, and other operations essential for autonomous operation. For example, an in a typical flight, a VTOL autonomous aircraft may depart a vertiport while in continuous communication with the vertiport over a C2 link. Information may be sent and received from autonomous aircraft before, during, and after flights using C2 links. Inbound autonomous aircraft can receive information over C2 links such as the availability of landing locations, critical route information, weather data, and so on.

Autonomous aircraft may be configured to make changes to planned flight operations in response to the reception of information about certain conditions. For instance, an in-flight autonomous aircraft may receive information, over a C2 link, about a weather condition at a planned destination that will prevent a safe landing. In response, the aircraft can divert to a backup destination. In another example, the VTOL autonomous aircraft may transmit real-time telemetry data, including its position, altitude, and system status, to a C2 device at the vertiport. Upon learning of a hazardous condition at the aircraft's destination vertiport, the C2 device can output commands to cause the VTOL autonomous aircraft to divert to an alternate vertiport or to return to the starting vertiport.

When a C2 link to an autonomous aircraft becomes unavailable, for any reason, during flight operations, the autonomous aircraft is typically configured to fall back on pre-programmed, failsafe plans or actions in concert with onboard sensors to safely complete the flight without interaction with a remote monitoring station over the C2 link. These procedures are necessary because, absent a functional C2 link, there may be no way to communicate or direct the autonomous aircraft.

Thus, in some cases, loss of a C2 link with an autonomous aircraft can jeopardize completion of the flight and may have implications for safety. For example, without a C2 link the aircraft could automatically deviate from its planned flight path in accordance with preplanned instructions in an unsafe manner, enter unanticipated weather conditions, or fail to respond to directions from air traffic control (ATC).

To address these challenges, techniques for outputting vertiport conditions to aircraft using standardized message protocols are provided. For example, a standardized message protocol such as Automatic Dependent Surveillance-Broadcast (ADS-B) can be used for communication with autonomous aircraft, vehicles, or vessels to pass information such as hazards to landing without the need for the communication systems, such as the C2 link, to be operational. The information can be sent using existing, standardized ADS-B message formats, extended or modified message formats based on the standardized ADS-B message format, or new formats developed based on the ADS-B system, or others similar protocols. For instance, ADS-B messages can be used to transmit information from vertiports to inbound VTOL autonomous aircraft relating to the status of vertiport infrastructure, ground obstacles, airspace or maritime obstacles, or other information necessary for safely and successfully completing an autonomous flight.

The following non-limiting example is provided to introduce certain concepts. Consider a landing area such as a vertiport and an inbound VTOL autonomous aircraft. In this example, the inbound VTOL autonomous aircraft is following a flight plan that includes landing at the vertiport. However, a condition exists at the vertiport such as inclement weather or a physical condition at the landing area (e.g., an object or damage detected at the landing area using one or more sensors or cameras deployed at or around the landing area). Moreover, the C2 link between the vertiport and the VTOL autonomous aircraft is lost due to an equipment failure and the aircraft is “squawking 7400,” referring to a transponder setting indicative of a loss of C2 link.

In this event, vertiports and VTOL autonomous aircraft may use other communications equipment that can provide some functionality that is lost when a C2 link is unavailable. For instance, vertiports and VTOL autonomous aircraft may both be equipped with equipment suitable for using the ADS-B protocol to communicate. ADS-B is an example of a protocol used for active, automated communication among ground-based transmission systems, other aircraft, vehicles, vessels, and satellite-based systems. ADS-B is used to, for example, enhance aircraft safety by providing locating data to other aircraft, vehicles, vessels, or fixed locations (e.g., ground installations, vertiports, etc.) for collision avoidance and other roles such as traffic management, airspace optimization, and search and rescue operations. Some examples of the present disclosure involve using ADS-B as a communication device during a communication failure for an autonomous aircraft or other loss of C2 capabilities.

In this example, a computing device located at or communicatively coupled with a vertiport accesses a configuration for generating messages using a predetermined message format for an air traffic management device located at the vertiport. The air traffic management device may be, for example, a communication device that can send and receive ADS-B messages. The configuration can be accessed using, for example, air traffic management device configuration software and a suitable client device. For instance, the configuration may be a web application that can be accessed using a computer or tablet located at the vertiport.

Accessing the configuration associated with the air traffic management device can include reading, adding, updating, or removing content from ADS-B messages. ADS-B messages have a standardized, predetermined message format including a number of “fields.” In the context of this example, a field refers generally to a particular portion of an ADS-B message that can accept an alphanumerical data entry. The computing device updates the configuration with information about the condition at the vertiport using the predetermined message format. For example, a field of outgoing ADS-B messages can be populated with information about the condition at the vertiport.

The computing device then outputs, using the air traffic management device, an ADS-B message based on the updated configuration. The message is transmitted to an air traffic management device carried by the inbound VTOL autonomous aircraft when it is within a predetermined distance of the vertiport. For instance, the air traffic management device carried by the inbound VTOL autonomous aircraft may be a transponder that is configured to receive ADS-B messages. In some examples, upon receipt of the ADS-B message including information about the vertiport condition, the autonomous aircraft can be configured to automatically divert to a secondary or backup vertiport, or other alternative landing location. For example, if a particular touchdown and lift off (TLOF) area at the vertiport are not available (e.g., due to an obstruction) an alternative landing location within the vertiport may be available.

The innovations of the present disclosure provide significant improvements in the technical field of automated landing hazard avoidance systems. Existing approaches are dependent on working and reliable C2 links to broadcast hazards to landing or other important information to landing and departing autonomous aircraft. The techniques of the present disclosure enable the receipt of final approach or takeoff (FATO) conditions when an autonomous aircraft is experiencing a loss of C2 link casualty. Autonomous aircraft can thus be safely redirected or otherwise informed and updated about ground or landing conditions using equipment that may be operable even in the face of a loss of a C2 link. Moreover, because the ADS-B protocol can involve recipients of messages rebroadcasting received messages, the likelihood of successful communications is even greater than if some other possible communication systems were repurposed. Similarly, the use of ADS-B or similar protocols may enable messages to be send from aircraft to aircraft in addition to the ground to aircraft example above. Implementations of systems for outputting vertiport conditions to aircraft using standardized message protocols can be fully automated, without requirement for monitoring by operations personnel at vertiports or aircraft. Additionally, the techniques described herein are scalable, leaving the door open for additional uses of the ADS-B protocol while adding no significant burden to the existing ADS-B network.

In addition to these improvements, the techniques described for outputting vertiport conditions to aircraft using standardized message protocols involve computing devices in various respects and can improve the functioning thereof. Specifically, the techniques may involve using already-existing fields in ADS-B messages that would have been sent in any event. Thus, in the event of a C2 link failure, the utility of the computing devices sending and receiving ADS-B (or other similar protocol) messages is improved without a concomitant increase in the consumption of computational resources. Additionally, in some examples, the techniques of the present disclosure may be used to replace certain functions presently performed by C2 links, even in non-casualty situations. Where the consumption of computational resources is greater by active C2 links, such consumption may be reduced by the preferable use of existing fields in ADS-B messages.

These illustrative examples are given to introduce the reader to the general subject matter discussed herein and the disclosure is not limited to these examples. The following sections describe various additional non-limiting examples of systems and methods for outputting vertiport conditions to aircraft using standardized message protocols. Throughout this disclosure, various example may refer to vertiports, autonomous aircraft, or VTOL autonomous aircraft, but this should not be construed as limiting. Some aspects of the present disclosure may be employed in a variety of settings including other kinds of ground-based installations, aircraft, vehicles, vessels, and so on.

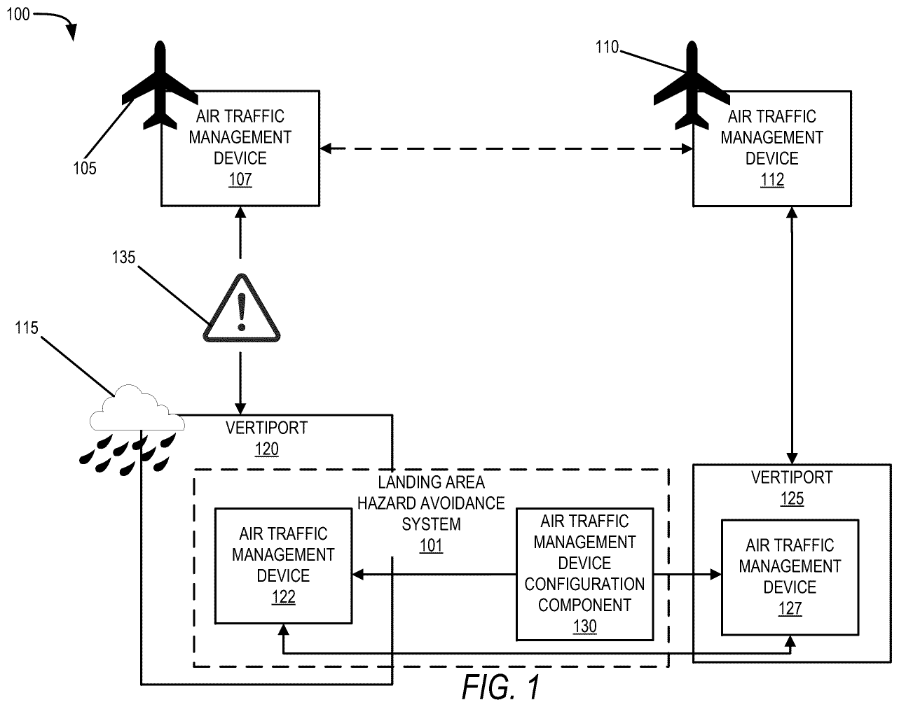

Turning first to FIG. 1, FIG. 1 is a block diagram of an example system 100 for outputting vertiport conditions to aircraft using standardized message protocols, according to some aspects of the present disclosure. System 100 includes two aircraft 105, 110 each including a respective air traffic management device 107, 112. The aircraft 105, 110 may be, for example, autonomous aircraft with VTOL capabilities, however the techniques of the present disclosure apply equally to any aircraft, vehicle, or vessel equipped with capability to send or receive ADS-B messages, or other comparable protocol.

The air traffic management devices 107, 112 may include one or a combination of components for air traffic management functions such as collision avoidance, landing hazard avoidance, weather monitoring, communication among various locations, among others. In some examples, the air traffic management devices 107, 112 include a transponder component, such as a Mode S transponder. A Mode S transponder is a device installed on some aircraft 105, 110 that includes a transmitter component, a receiver component, a control interface, and an antenna for broadcasting and receiving signals. The Mode S transponder is configured to encode and transmit information such as aircraft identification information, altitude, or a four-digit “squawk” code assigned by ATC for help identifying the aircraft 105, 110 on radar screens and other ATC devices.

In some examples, the Mode S transponders included in air traffic management devices 107, 112 are further equipped with “ADS-B Out” capabilities. For example, some Mode S transponders can send and receive ADS-B messages using same frequency band as the Mode S transponder. In some examples, the air traffic management devices 107, 112 can be further augmented with additional “ADS-B In” equipment (e.g., a receiver or transceiver) to supplement the ADS-B reception capabilities of the Mode S transponder. In such configurations, the additional “ADS-B In” equipment can enable the reception of broadcasted ADS-B messages from nearby aircraft or ground facilities, enhancing the Mode S transponder's ability to integrate real-time traffic and airspace information and enabling additional operational features such as conflict detection and resolution.

System 100 also includes two landing areas (e.g., vertiports 120, 125) each including a respective air traffic management device 122, 127. Together with at least an air traffic management device configuration component 130, as described below, the air traffic management device 122 make up a landing area hazard avoidance (LHA) system 101. The landing area hazard avoidance system 101 includes components for outputting vertiport conditions to aircraft using standardized message protocols, including accessing configurations for generating messages using a predetermined message formats (e.g., ADS-B), updating configurations with information conditions at the landing areas, and outputting messages based on the configurations to incoming aircraft to prevent collisions or other accidents or determinantal events during landing or takeoff operations. System 100 depicts the LHA system 101 as inclusive of the air traffic management device 122 associated with landing area 120, but in some examples the LHA system 101 may include air traffic management devices 122, 127 at multiple landing areas 120, 125 networked together.

The vertiports 120, 125 include facilities designed for VTOL aircraft such as helicopters or fixed wing aircraft. Vertiports 120, 125 may include platforms or pads for landing and departing aircraft. Some vertiports 120, 125 may additionally include various support infrastructure such as charging infrastructure for electrically powered VTOL aircraft, hangars for maintenance and storage, passenger terminals, and so on. To support FATO operations, vertiports 120, 125 can be equipped with navigation aids, operational lighting, emergency safety equipment, and ATC systems. The air traffic management devices 122, 127 may likewise be used to facilitate communications with other facilities with FATO capabilities (e.g., backup landing locations), other vertiports 120, 125, or landing and departing aircraft 105, 110.

The air traffic management devices 122, 127 may differ in some respects from the air traffic management devices 107, 112 equipped on aircraft 105, 110. For instance, in some embodiments, the air traffic management devices 122, 127 may not include Mode S transponders, which is equipment that is typically only carried by aircraft. However, the air traffic management devices 122, 127 may include transceivers capable of sending and receiving ADS-B messages that can be received by the air traffic management devices 107, 112 equipped on aircraft 105, 110. The air traffic management devices 122, 127 may be, for example, 1090ES ADS-B-compatible transponders. In this example, 1090 refers to the primary frequency of operation (1090 MHz) and the ES refers to “Extended Squitter” mode, discussed further below. Conversely, the ADS-B messages sent and received by the air traffic management devices 107, 112 equipped on aircraft 105, 110 may be received by the air traffic management devices 122, 127 at vertiports 120, 125.

The air traffic management devices 122, 127 may include one or more computing devices for configuring, operating, or maintaining the air traffic management devices 122, 127. The computing devices may include hardware such as laptops, desktops, tablets, smartphones, and so on. Some examples may include remote servers or cloud-based compute services, or any combination of these elements. For instance, configuration shared among air traffic management devices 122, 127 located at different vertiports 120, 125 could be hosted in a cloud-based web configuration system (e.g., a web application) that uses data stored in a database in a remote server and accessed using laptop computer client devices at vertiports 120, 125. For example, some air traffic management devices 122, 127 may be integrated with vehicle management systems installed at some vertiports 120, 125 which can be used for communicating with autonomous aircraft.

An example of such a configuration system, is shown in example system 100. Air traffic management devices 122, 127 can be configured using the air traffic management device configuration component 130. The air traffic management device configuration component 130 can be used for, for example, accessing the configuration for generating messages using predetermined message formats for the air traffic management devices 122, 127 or updating the configuration with information such as landing hazard or inclement weather conditions at the vertiports 120, 125. The air traffic management device configuration component 130 is depicted in FIG. 1 as external to the vertiports 120, 125 and respective air traffic management devices 122, 127. However, in some examples, the air traffic management device configuration component 130 may be located locally with the air traffic management devices 122, 127 or may be a component thereof. In some examples, the air traffic management device configuration component 130 is used only for configuration of the local air traffic management device (122 or 127) and is not used for shared configuration among disparate devices or vertiports.

System 100 schematically depicts a condition 115 affecting vertiport 120. The condition 115 may be any of a number of conditions that may make FATO operations at or the vicinity of vertiport 120 impossible, unsafe, or otherwise untenable. For example, the condition 115 may be adverse weather, technical or equipment failures, physical obstructions, emergency situations, security threats, and so on. Concurrently, system 100 depicts a C2 link failure 135 between vertiport 120 and aircraft 105. The C2 link failure could be caused by, for example, radio frequency interference, a hardware or software malfunction, signal obstruction, and so on. In some examples, each vertiport 120 can be equipped with an independent ADS-B transponders used for coordinating autonomous operations at multiple vertiports 120, 125. For instance, navigational comparison can be used to compare navigation data or aid in landing augmentation, using the timing signal of the ADS-B messages under some conditions.

In some examples, the condition 115 affecting vertiport 120 can be detected at the vertiport 120 using one or more sensors or cameras provided around the vertiport 120. For example, smoke detectors, heat sensors, gas leak sensors, and the like can be used to detect the presence of fire which may be indicative of a condition 115 preventing landing operations. High-definition cameras with thermal imaging capabilities can be similarly located at vertiport 120 to detect fire and other hazards. In some examples, a trained ML model can be used to detect various conditions identified using the cameras that may prevent aircraft from landing at vertiport 122.

Using the techniques disclosed herein, the air traffic management device 122 at vertiport 120 can output, for example, an ADS-B message based on a configuration configured using the air traffic management device configuration component 130. For example, the ADS-B message can be transmitted to the air traffic management device 107 equipped on aircraft 105 when aircraft 105 is within a predetermined distance of the vertiport 120 or otherwise preparing to approach or land at vertiport 120. The aircraft 105 can be configured to automatically divert to an alternative landing location such as vertiport 125 upon receipt of such information.

In some examples, the ADS-B message can be transmitted automatically following detection of the condition 115 affecting vertiport 120. For example, a camera at vertiport 120 may detect a possible obstruction and an ML model may be used to predict that the obstruction is likely to be a hazard to aircraft. The air traffic management device configuration component 130 can be configured to automatically transmit an ADS-B message to incoming aircraft without any requirement for manual intervention by ATC personnel. Similarly, the air traffic management device configuration component 130 can be configured to notify ATC personnel upon detection of a possible hazard to incoming aircraft and to recommend and prepare an ADS-B message for transmission.

An ML model used for classification or prediction of hazards identified using cameras or other sensor data may be implemented using convolutional neural networks (“CNNs”) for spatial feature extraction or transformers for capturing spatial-temporal dependencies. These or similar architectures can be trained to detect, classify, or forecast hazardous conditions based on visual or multi-modal inputs. In addition to these examples, the ML model may include other ML components or any combination thereof including, for example, recurrent neural networks (“RNNs”), long short-term memory networks (“LSTMs”), gated recurrent units (“GRUs”), attention mechanisms, autoencoders (“AEs”), variational autoencoders (“VAEs”), generative adversarial networks (“GANs”), graph neural networks (“GNNs”), spiking neural networks (“SNNs”), normalization layers (e.g., batch normalization, layer normalization), pooling layers (e.g., max pooling, average pooling), and ensemble models, among others.

In some examples, a language model such as a large language model (“LLM”) can be used to automatically generate ADS-B messages given information about a condition 115 at the vertiport 120. For example, a weather forecast or an image or text-based description of the condition 115 can be provided to an LLM along with a suitable prompt to generate an ADS-B message. The prompt can include a specification of the ADS-B message format.

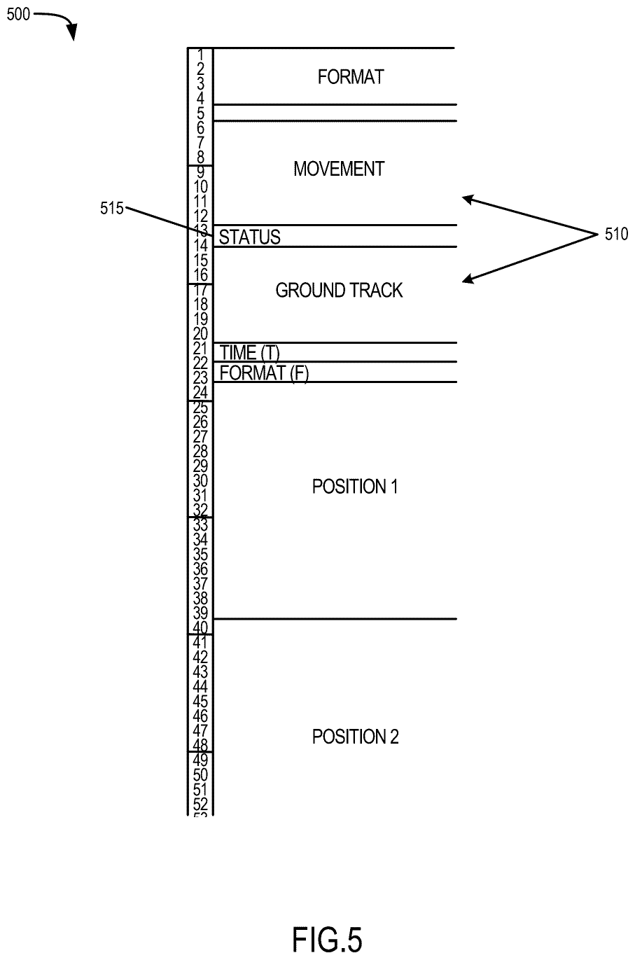

The LLM used for this purpose may be a self-hosted LLM or a third-party LLM accessible using a web-based API or other suitable method for remote access. A self-hosted LLM can refer to an LLM that is pre-trained and deployed on a computing environment operated by the vertiport 120 (or other ground-based installation) such as server hardware, virtual machines, or a cloud computing environment. Examples of popular self-hosted LLMs include Meta's Llama 2 and 3, Mistral (https://mistral.ai/), Falcon (https://falconllm.tii.ae/), the MPT models of the MosaicML Foundation series, and BLOOM (https://bigscience.huggingface.co/), among many others. Examples of third-party LLMs include the OpenAI GPT/ox series, the Claude models by Anthropic, Google's Gemini series, among many others. These examples are provided for context and are not intended to be limiting in any way. An example prompt for generation of an ADS-B message is described below in FIG. 5.

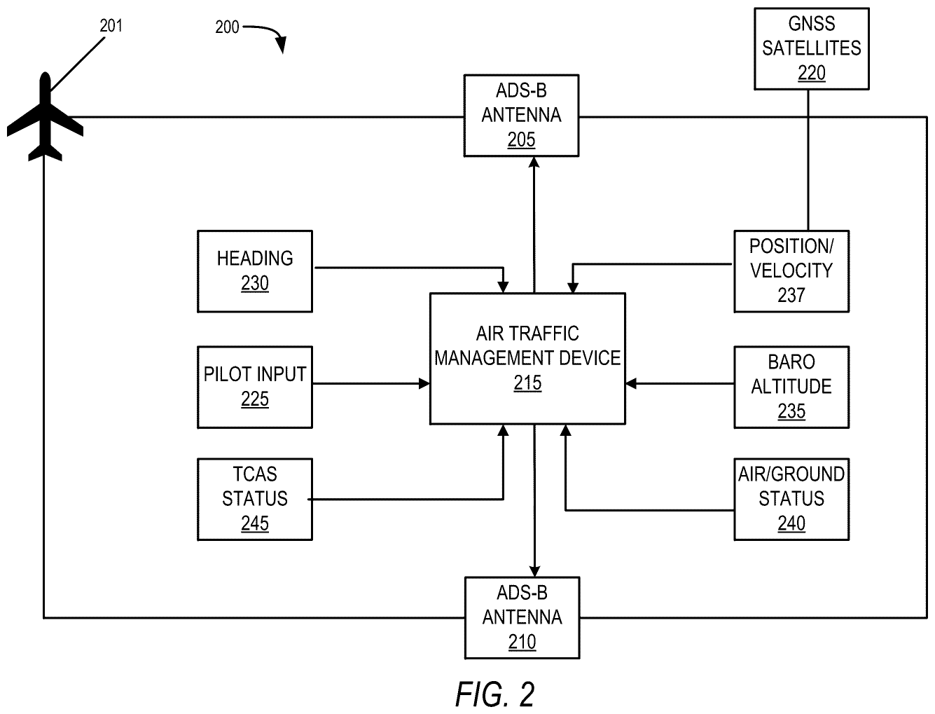

Turning next to FIG. 2, FIG. 2 is a block diagram of an example system 200 for sending and receiving ADS-B messages, according to some aspects of the present disclosure. In some examples, the system 200 may be disposed in an aircraft, vehicle, or other vessel. Some components of system 200 may, for example, be housed in the avionics bay of an aircraft, situated near the front of the aircraft, beneath the cockpit, but other arrangements may be found according to the particular configurations of various aircraft, vehicles, or other vessels.

The system 200 may be independent of any other aircraft, vehicle, vessel, or other communication installation (e.g., an ADS-B system installed at a landing area such as a vertiport) and is this respect a standalone receiver and transmitter. The system can be operated in receive-only or receive and transmit modes. In some examples, the system 200 may include a weather mode in which weather services can deliver real-time meteorological information to aircraft from ground-based stations broadcasting ADS-B messages. Most aircraft, vehicles, or vessels equipped with ADS-B equipment such as system 200 operate at least in the receive-only mode to receive information from a ground- or space-based systems or other aircraft, vehicles, or vessels independently of any other communication systems installed on the aircraft, vehicles, or vessels, such as C2 links.

The system includes an air traffic management device 215 that includes components for ADS-B transmission and reception. The air traffic management device 215 may be, for example, a transponder or a transceiver. For instance, as discussed above with respect to FIG. 1, the air traffic management device 215 may use extensions of a Mode S transponder for transmitting ADS-B communications. In that case, the air traffic management device 215 may further include an ADS-B In receiver for receiving and processing ADS-B transmissions from other aircraft and vertiports.

During normal operations, the air traffic management device 215 including components for ADS-B transmission and reception can be used to continuously transmit information about the aircraft 201 such as the aircraft ID, position, altitude, or velocity. Likewise, the air traffic management device 215 can continuously receive such information from other aircraft as well as information from ground-based locations with ADS-B equipment or the like. For example, aircraft equipped with an air traffic management device 215 including components for ADS-B transmission and reception can receive Traffic Information Services-Broadcast (TIS-B) or Flight Information Services-Broadcast (FIS-B) information including aircraft position reports, radar images, METARs, TAFs, AIRMETs, SIGMETSs, PIREPs, winds and temperatures aloft, NOTAMs, information on temporary flight restrictions, and so on.

The system 200 may include one or more ADS-B antennas 205, 210. The antennas 205, 210 can receive and transmit ADS-B information. In some configurations, one or more antennas 205, 210 may be mounted on the exterior of the aircraft 201 to maintain line-of-sight (LOS) with satellites or ground stations (e.g., vertiports). For example, a first antenna 205 may be mounted on the top of the aircraft 201 for satellite LOS and a second antenna 210 may be mounted on the bottom or front of the aircraft 201 for LOS with, for example, a destination vertiport. In some examples, a vertiport may output, using a suitable ADS-B transceiver, an ADS-B message with information about a landing hazard to an aircraft 201 within a predetermined distance of the first vertiport. The predetermined distance may be determined, in some examples, based on the factors including the location of the bottom-mounted antenna 210, weather, local obstructions, aircraft 201 altitude, and so on.

The system 200 can receive information from one or more satellites 220, such as a global navigation satellite system (GNSS) satellite (e.g., GPS). The satellites 220 can provide positioning, navigation, and timing data to the system 200, enabling, for example, accurate determination of the three-dimensional position of the aircraft 201.

The system 200 can receive information by way of pilot input 225. Pilot input 225 can be used to input or modify flight data that can be included or used to modify information included in transmitted ADS-B messages. For example, pilot input 225 can be used for making real-time updates or corrections to message content such as planned destination, altitude, or heading. In some embodiments, pilot input 225 may be provided by a ground controller overseeing the flight path and flight conditions of an autonomous aircraft. That is, the pilot input 225 maybe provided by an entity physically located outside of the aircraft (e.g., on a ground control facility).

ADS-B message content can likewise receive information from a number of on-board sources such as a heading indicator 230, a barometric altitude indicator 235, a position/velocity indicator 237, or an air/ground state component 240 that provides information about whether the aircraft is airborne or on the ground, that can, for example, affect the transmission frequency of ADS-B signals. Additional information may be used by the system 200 for generating ADS-B messages including information from a Traffic Collision Avoidance System (TCAS) 250. The TCAS can receive transponder information from other aircraft and determine other transponder-equipped aircraft may present a threat of mid-air collision.

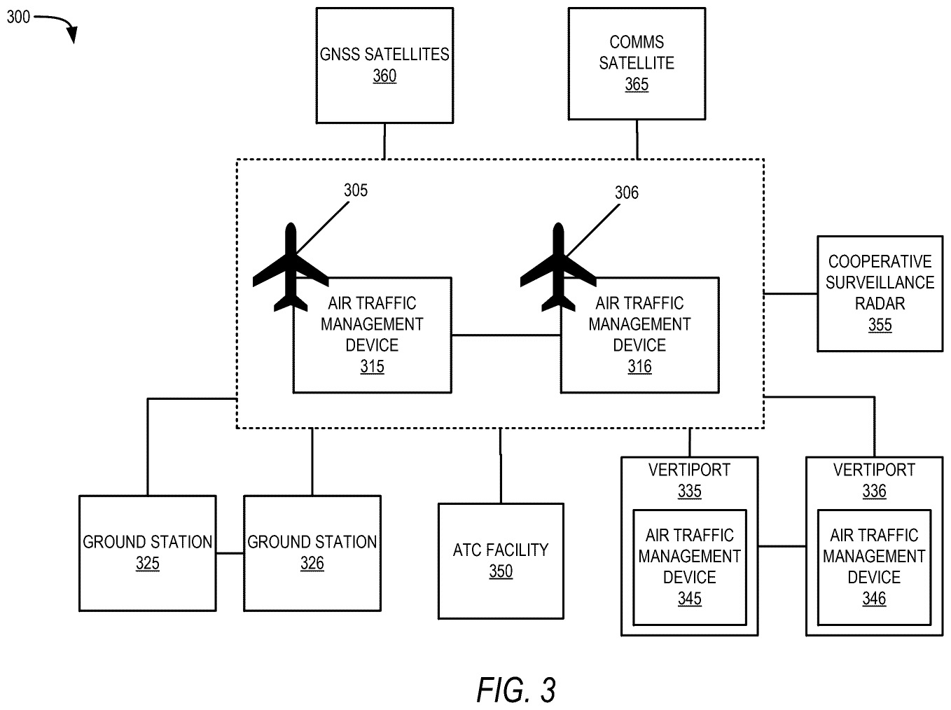

Turning next to FIG. 3, FIG. 3 is a block diagram of an example system 300 including components for an ADS-B network, according to some aspects of the present disclosure. System 300 depicts the system 200 of FIG. 2 in the context of a network of devices that can send and receive ADS-B messages. For example, system 300 includes aircraft 305, 306 equipped with air traffic management devices 315, 316. The air traffic management devices 315, 316 may be similar in some respects to the air traffic management device 215 depicts in FIG. 2. For instance, air traffic management devices 315, 316 may be Mode S transponders with ADS-B send and receive capabilities or other suitable devices for ADS-B operations. Note that FIG. 3 depicts the aircraft 305, 306 and respective air traffic management devices 315, 316 inside a dashed line with connections to the components discussed below for simplicity. Implementations of system 300 may include many more interconnections among the networked components than are shown in FIG. 3.

The system includes ground stations 325, 326 that can receive ADS-B transmissions from aircraft 305, 306 and relay the transmissions to installations such as airports, landing areas such as vertiports 335, 336, or air traffic control (ATC) facilities 350. The ground stations 325, 326 may be equipped for ADS-B including wide area multilateration (WAM) support. WAM can include a network of ground stations 325, 326 or other sensors that are deployed throughout a desired coverage area to provide complementary coverage to ADS-B devices equipped on aircraft 305, 306 or vertiports 335, 336. System 300 also includes cooperative surveillance radar 355 that can provide secondary surveillance radar (SSR) data, such as altitude and identification of aircraft, to supplement ADS-B messages received by aircraft 305, 306 or vertiports 335, 336.

Vertiports 335, 336 likewise include air traffic management devices 345, 346 for exchanging ADS-B messages with aircraft 305, 306 for outputting vertiport conditions to aircraft using standardized message protocols such as ADS-B. Some vertiports 335, 336 may be co-located with an ATC facility 350 that can process and display air traffic data received from ADS-B ground stations and other surveillance systems to manage aircraft movements safely and efficiently. In some examples, the air traffic management devices 345, 346 can be configured to continuously monitor conditions at landing locations at the vertiports 335, 336 and automatically output information about the conditions to aircraft using standardized message protocols such as ADS-B.

The system 300 include GNSS satellites 360, such as GPS, BeiDou/BDS, Galileo, or GLONASS that can provide positioning, navigation, and timing (PNT) services to aircraft 305, 306. System 300 also includes communications satellite 365. Communications satellite 365 includes an ADS-B receiver that can receive transmissions from the air traffic management devices 315, 316 of aircraft 305, 306 and send/rebroadcast transmissions to airborne or ground-based ADS-B receivers.

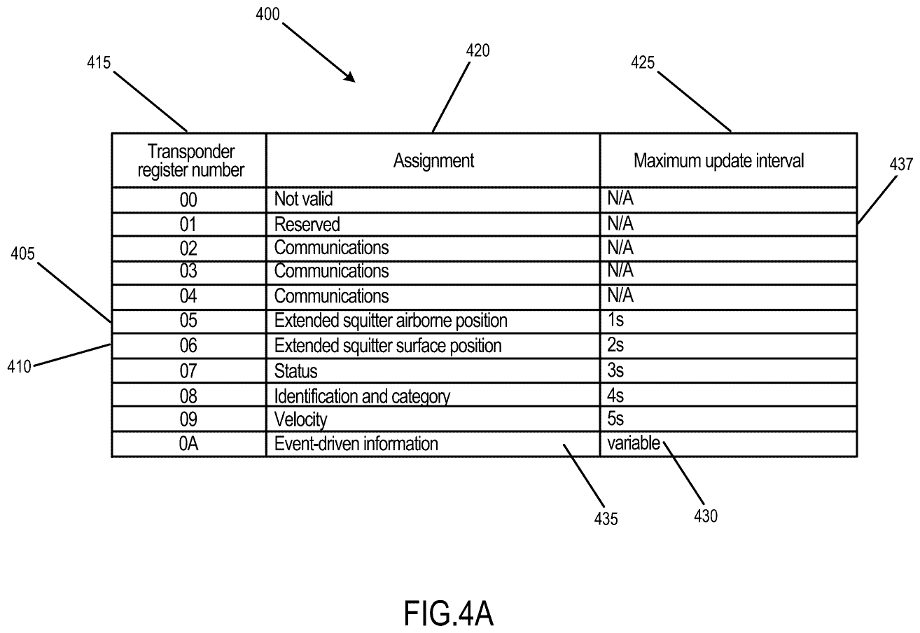

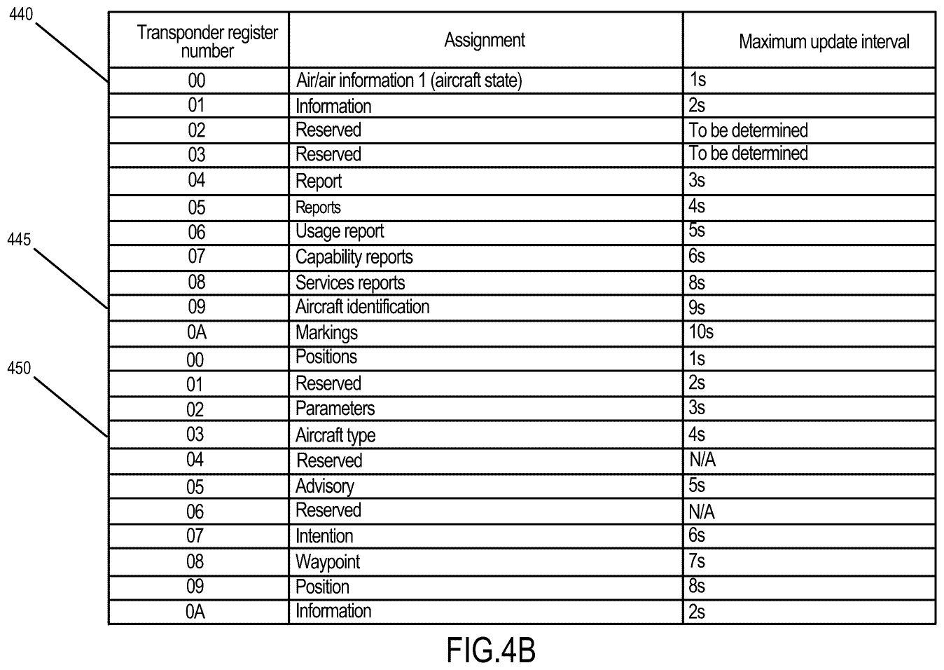

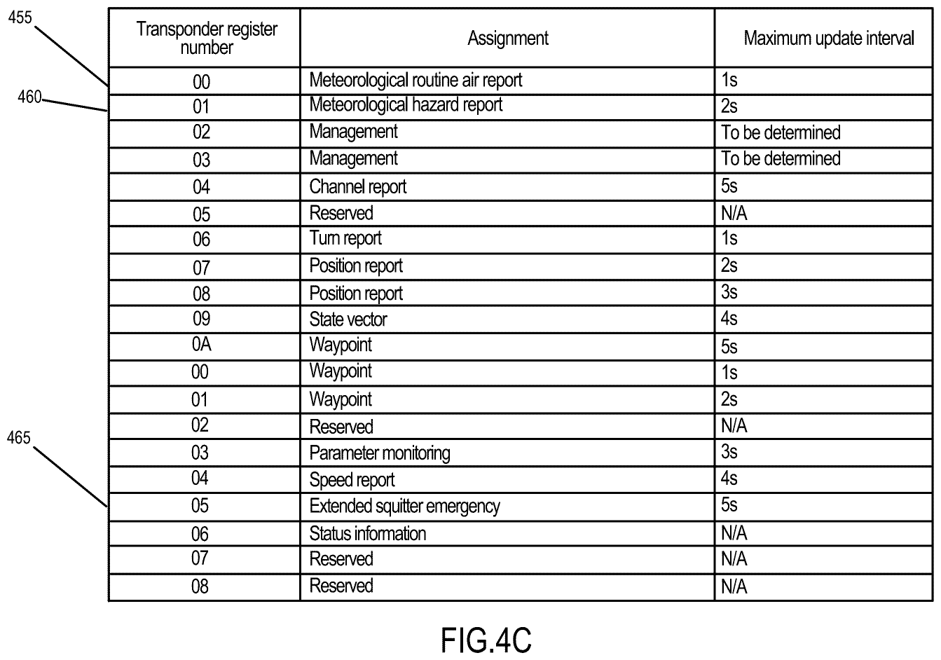

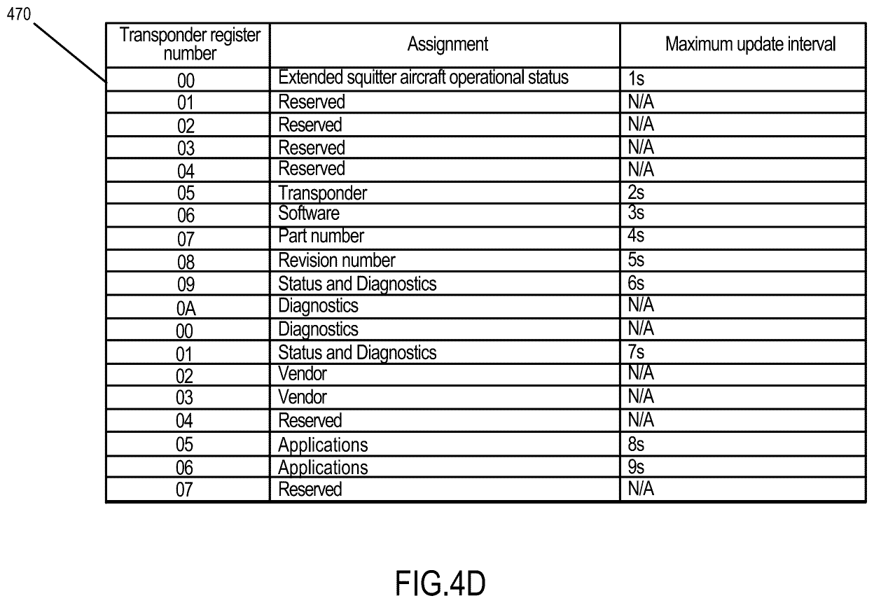

Turning next to FIGS. 4A-4D, FIGS. 4A-4D depict a representation of ADS-B message fields 400 that may be used for outputting vertiport conditions to aircraft using standardized message protocols, according to some aspects of the present disclosure. In some examples, the message fields 400 may correspond to registers in an ADS-B transponders or other similar equipment. A register, in this context, can refer generally to predefined memory locations in a computing device that map to fields in a message, such as an ADS-B message.

The fields 400 are shown in a tabular format including a transponder register number 415. The transponder register number 415 is shown as a two-digit hexadecimal number (base 16 number) that can identify the particular register associated with an information assignment 420. Each register number 415 and corresponding information assignment 420 is further associated with a maximum update interval 425. The maximum update interval 425 can correspond to the maximum periodicity that a particular message field should be updated at, according to a particular specification of a standard. For instance, to conserve bandwidth and ensure adequate performance, a particular register may be updated at a maximum of once every 0.2 seconds, as indicated by the maximum update interval 425.

The registers may be used by ADS-B devices for generating ADS-B messages. For examples, particular message types may use certain registers according to the type of information being transmitted. For instance, an ADS-B message output by an aircraft that includes aircraft position may use the register 405 designated for “Extended squitter airborne position,” while a message including aircraft surface position may use the register 410 assigned for “Extended squitter surface position.” Extended squitter (ES), in the ADS-B context, can refer to enhanced message formats used in some ADS-B equipment that can be used to achieve higher update rates or improved bandwidth. An example of the ADS-B message format into which a subset of the fields 400 can be used is shown in FIG. 5 and the accompanying description.

In some examples, ADS-B messages are generated in accordance with a standardized message format. For instance, organizations such as the International Civil Aviation Organization (ICAO) may develop message specifications or formats for ADS-B messages. The standardization of ADS-B messages can enable the efficient sending and receiving data, since ADS-B equipment can minimize the consumption of bandwidth with formatting or other descriptive metadata. Some examples of the present disclosure may be implemented in cooperation or in concert with such standardization organizations.

FIG. 4A includes an example of a register with a variable maximum update interval 430. Fields with a variable maximum update interval 430 may be used to provide event-driven or “as-needed” data transmissions. In some examples, a variable maximum update interval 430 can be used to send messages including various information including emergency or priority status. In this example, the register 435 is assigned to “Extended squitter event-driven information” according to the example specification of fields 400. In this example, the “event-driven information” can include information about conditions at vertiports that may cause autonomous aircraft to divert to alternative landing locations in some circumstances.

Some ADS-B message fields are designated, in a suitable standard, as an open, unspecified, or miscellaneous data field. Such open fields can be used, for example, to send information to the aircraft 201 from a vertiport or other ground-based location other than what is typically sent. For instance, an open field can include weather data, relayed messages from other aircraft, vehicles, or vessel or safety information. Reserved field 437 is an example of an open or unspecified field that can be used for outputting vertiport conditions to aircraft using standardized message protocols in some examples.

FIG. 4B includes several examples of message fields 400 that can be used for outputting vertiport conditions to aircraft using standardized message protocols. Field 440 is designated, in the example specification, as assigned to “Air/air information 1 (aircraft state).” In some examples, field 440 can be used to convey information such as vertiport FATO status. For instance, field 440 can be used to convey information as to whether a vertiport is open or closed, operational or not, occluded by weather or not, and so on. Field 445 is designated, in the example specification, as assigned to “Aircraft identification.” In some examples, field 445 can be used to convey a vertiport identification number to incoming autonomous aircraft or other vehicles. Field 450 is designated, in the example specification, as assigned to “Aircraft type.” In some examples, field 450 can be used to identify an ADS-B message as originating from a vertiport or other similar type-identifying information.

FIG. 4C includes several more examples of message fields 400 that can be used for outputting vertiport conditions to aircraft using standardized message protocols. Field 455 is designated, in the example specification, as assigned to “Meteorological routine air report.” In some examples, field 455 can be used to convey a vertiport weather data to incoming autonomous aircraft or other vehicles. Field 460 is designated, in the example specification, as assigned to “Meteorological hazard report.” In some examples, field 460 can be used to convey a vertiport weather hazard data to incoming autonomous aircraft or other vehicles. Field 465 is designated, in the example specification, as assigned to “Extended squitter emergency/priority status.” In some examples, field 465 can be used to convey a vertiport FATO priority status or information about vertiport emergencies.

FIG. 4D includes another example of a message field 400 that can be used for outputting vertiport conditions to aircraft using standardized message protocols. Field 470 is designated, in the example specification, as assigned to “Extended squitter aircraft operational status.” In some examples, field 470 can be used to convey a vertiport terminal area operational capabilities or approach and landing operational capabilities. For instance, field 470 may include information about the type, size, materials, constructions, and so forth, of a given vertiport that can be used by an autonomous aircraft to determine takeoff or landing flight plans.

The air traffic management device configuration component 130 can be used to insert alphanumerical data in one or more fields (e.g., 455, 460, 465 of FIG. 4C) to convey the related information as described above. For example, the air traffic management device configuration component 130 may provide a suitable UI that enables a user or administrator to view, populate, edit, or delete alphanumerical data from selected fields. The air traffic management device configuration component 130 can display a UI that shows the information shown in the tables of FIGS. 4A-4D including the transponder register number 415, information assignment 420, or maximum update interval 425. In some examples, these values may be configurable or otherwise editable.

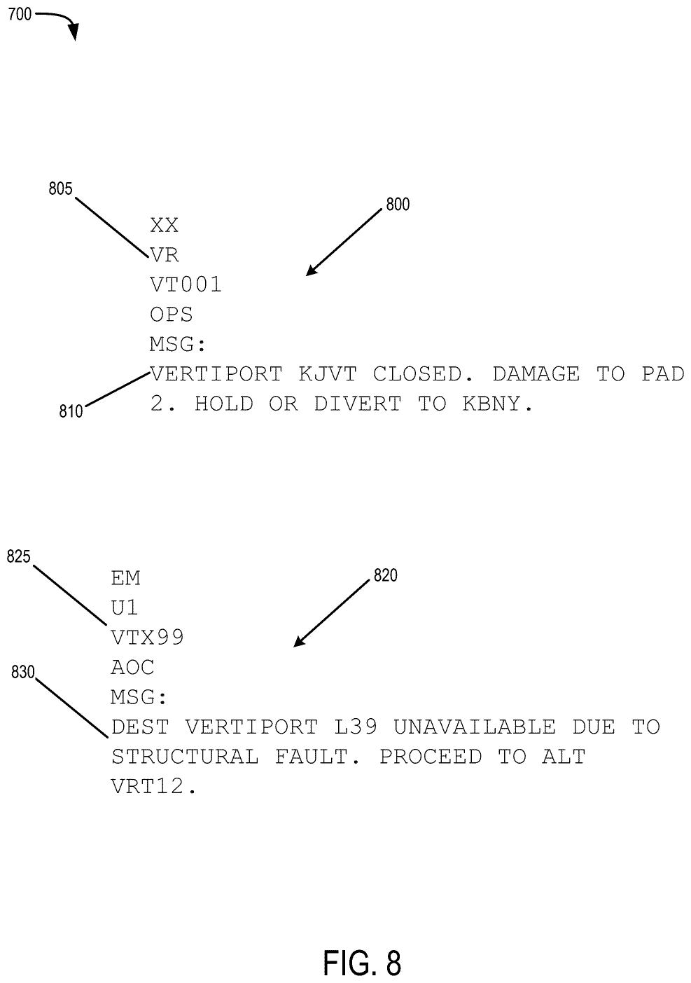

It should be noted that the example fields 400 discussed with respect to FIGS. 4A-4D are just examples based on the example ADS-B specification shown in FIGS. 4A-4D. Other fields 400, besides the examples given, may be used in lieu of or in addition to the examples given. Moreover, other message protocols besides ADS-B can be used for outputting vertiport conditions to aircraft using standardized message protocols as well as other specifications of the ADS-B protocol. For example, some aspects of the present disclosure may be implemented using related technologies such as aircraft communications addressing and reporting system (ACARS). ACARS is an example of a communications system used for transmission of short messages between aircraft and ground stations with a similarly flexible messaging format that could be adapted for use in outputting vertiport conditions to aircraft using standardized message protocols. An illustration of ACARS and message fields used therein that may be used for outputting vertiport conditions to aircraft using standardized message protocols is shown below in FIG. 8.

Turning next to FIG. 5, FIG. 5 is an example of an ADS-B message specification 500 according to some aspects of the present disclosure. Example message specification 500 depicts an ADS-B message based on a particular set of registers. For example, the registers on which message specification 500 is based may be based on field 410 from among the fields 400 in FIG. 4 above. In message specification 500, the information in register 410 is assembled according to a well-defined specification as shown in message sections 510. Message sections 510 show aircraft movement and ground track information as it may be extracted, bitwise, from register 410. For instance, aircraft movement may be encoded using a specified number of bits. The ADS-B specification may include information needed to encode and decode the movement information. Various examples of message specifications may use one or a number of registers to generate a particular ADS-B message. In some examples, the message specification 500 may be a representation of the “ME” field of the extended squitter portion of an ADS-B message, which includes 56 bits and encodes data content according to certain ADS-B specifications.

In some examples, message specifications such as message specification 500 can be generated for outputting vertiport conditions to aircraft using standardized message protocols. The message specifications thus generated can be used in lieu of or in addition to the standardized message specification, such as message specification 500, to include, for example, information about conditions at landing areas such as vertiports that can be sent using ADS-B equipment to incoming aircraft. For instance, status bit 515 of message specification 500 could be used to indicate vertiport operational status (e.g., open or closed), according to some examples.

As described above with respect to FIG. 1, ADS-B messages for outputting vertiport conditions to aircraft using standardized message protocols can be generated using ML tools such as LLMs. In some examples, a multimodal LLM (e.g., an LLM that can process both images and text) can be prompted to generate an ADS-B message given information about the vertiport such as a picture of a hazard in the landing area or a description of a hazard in the landing area. The LLM can be prompted as, “Generate a 56-bit ADS-B payload that characterizes the condition shown in the attached image.” The prompt may further include information mapping landing area hazards and conditions to shortened abbreviations or codes that are used by both the sending and receiving air traffic management devices.

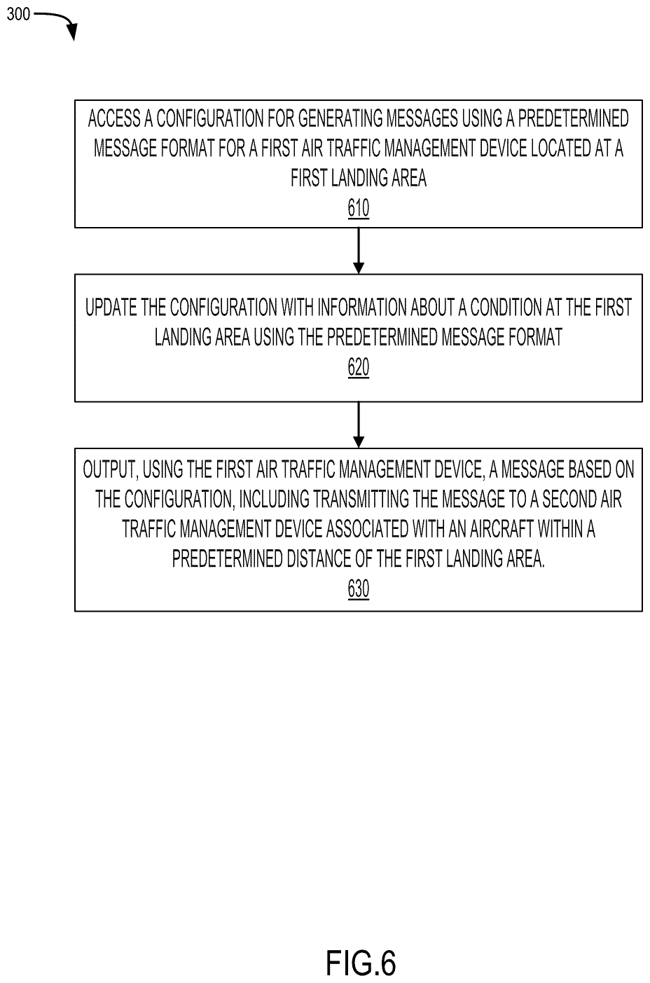

Referring now to FIG. 6, FIG. 6 shows a flowchart of an example method 600 for outputting vertiport conditions to aircraft using standardized message protocols, according to some aspects of the present disclosure. The description of the method 600 in FIG. 6 will be made with reference to FIGS. 1-5, however any suitable system according to this disclosure may be used. It should be appreciated that method 600 provides a particular method for outputting vertiport conditions to aircraft using standardized message protocols. Other sequences of operations may also be performed according to alternative examples. For example, alternative examples of the present disclosure may perform the steps outlined above in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For example, the description is given from the perspective of a computing device such as an air traffic management device located at a landing area such as a vertiport, but other configurations are possible. For instance, the method 600 could be performed by an air traffic management device located at a different vertiport or another communicatively coupled device such as an air traffic management device configuration component. One of ordinary skill in the art would recognize many variations, modifications, and alternatives.

Method 600 may include block 610. At block 610, a computing device accesses a configuration for generating messages using a predetermined message format for a first air traffic management device located at a first landing area. The configuration may be accessed using an air traffic management device configuration component 130, as shown in FIG. 1 above. For example, the first air traffic management device may include an ADS-B receiver component and an ADS-B transmission component. In some examples, the first air traffic management device may be communicatively coupled with an antenna configured for long-distance, LOS communications with landing and departing aircraft. In this case, the configuration may be accessed using a suitable user interface showing various portions of the ADS-B message format that can be modified and used to generate an ADS-B message.

Aircraft may be similarly equipped with ADS-B communications equipment, although the aircraft-based equipment may be configured differently from the ground-based equipment. For example, aircraft maybe equipped with a second air traffic management device that is a Mode S transponder. The Mode S transponder may include an ADS-B component configured to transmit and receive ADS-B messages. In some examples, the second air traffic management device may be further outfitted with an ADS-B In receiver configured to receive extended ADS-B messages. For instance, the Mode S transponder may only be suitable to receive a subset of possible ADS-B messages. In that case, an ADS-B In receiver may be required to receive additional or all possible ADS-B messages. In some examples, the ADS-B transponder can be operating in an extended squitter (ES) mode. In ES mode, the ADS-B transponder can transmit additional, more detailed flight information at a higher update rate.

At block 620, the computing device updates the configuration with information about a condition at the landing area using the predetermined message format. The condition may be, for example, a landing hazard or weather condition affecting the landing area. The configuration can be updated again using the air traffic management device configuration component 130. Updating the configuration may include adding, updating, or deleting information from one of a number of fields that can be used by the first air traffic management device to generate an ADS-B message.

The predetermined message format may be, for example, an ADS-B message, in which a message type is identified using an 8-bit register identifier. Likewise, the predetermined message format may include a number of fields. A field can refer generally to a particular portion of an ADS-B message. For instance, a message may have a format defined using individual bits of a predefined number of bits. A portion of those bits can be allocated to the ADS-B message or payload. The message or payload can be defined by the fields. For instance, an example ADS-B message may include a payload consisting of landing area operational status and weather conditions, both of which are fields. The fields may correspond to registers as defined in ADS-B specifications or as used by configuration or transmission equipment to generate ADS-B messages. Registers can refer generally to predefined memory locations in a computing device identified using a predefined identifier, such as a two-digit hexadecimal number. There may be a correspondence between the registers used by configuration equipment and the number of fields.

At block 630, the computing device outputs, using the first air traffic management device, a message based on the configuration, including transmitting the message to a second air traffic management device associated with an aircraft within a predetermined distance of the landing area. For example, the landing area such as a vertiport may be co-located with a radar system that can detect incoming autonomous aircraft. Upon a determination that the incoming aircraft is sufficiently close (e.g., close enough for LOS communications at a particular frequency), the first air traffic management device can transmit an ADS-B message to the incoming aircraft including information about the condition.

In some examples, the configuration can be automatically updated in response to changing conditions at the landing area. For example, the information about the condition may cause the computing device to automatically output the message without any requirement for manual intervention or interaction. For example, the computing device can employ ML models to detect the changing conditions at the landing area using sensors (e.g., cameras) or through continuous analysis of ATC or ground communications using LLMs. Additionally, an LLM can be prompted to monitor ATC or ground communications (e.g., as audio or transcribed) and to output a notification or alert when a potential hazard to incoming aircraft is detected. The LLM can be similarly prompted to generate the message in accordance with a specified ADS-B (or other message protocol) standard.

Upon receipt by the incoming aircraft, the message may cause a flight control computer of the autonomous aircraft to redirect to a second landing area (e.g., a different vertiport) or alternative landing location based on the condition. For instance, if a particular TLOF area at the landing area is not available, the autonomous aircraft may be redirected to an alternative landing location within the same landing area. If no alternatives are available at the same landing area, then the autonomous aircraft can be redirected to a different, second landing area. This capability to output landing area conditions to aircraft using standardized message protocols such as ADS-B can be particularly important when no C2 link is available to communicate with the incoming aircraft.

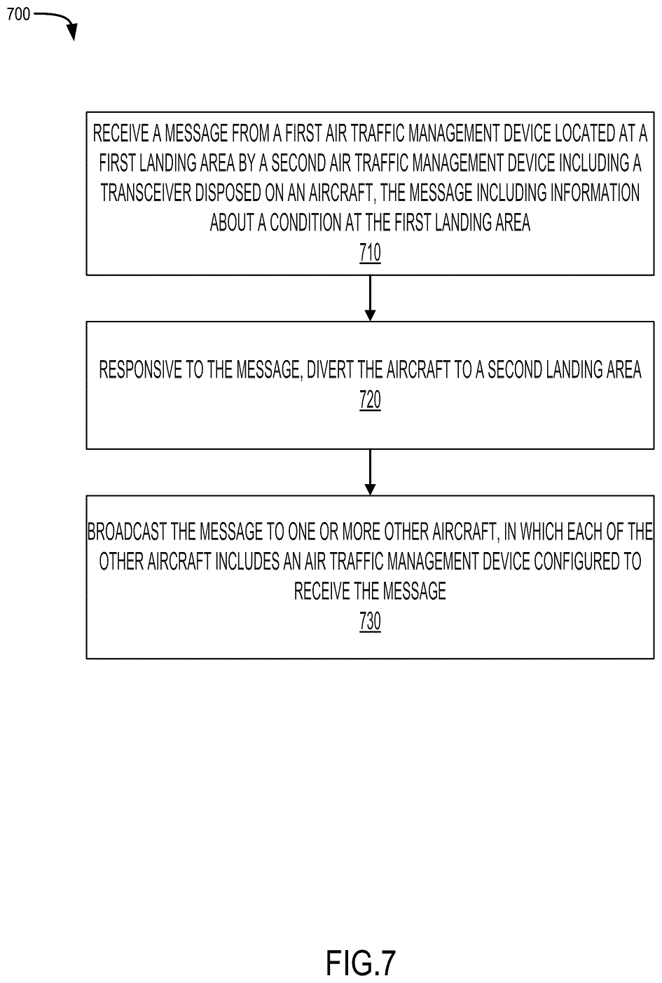

Referring now to FIG. 7, FIG. 7 shows a flowchart of another example method 700 for outputting vertiport conditions to aircraft using standardized message protocols, according to some aspects of the present disclosure. The description of the method 700 in FIG. 7 will again be made with reference to FIGS. 1-5, however any suitable system according to this disclosure may be used. It should be appreciated that method 700 provides a particular method for outputting vertiport conditions to aircraft using standardized message protocols. Other sequences of operations may also be performed according to alternative examples. For example, alternative examples of the present disclosure may perform the steps outlined above in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices. For example, the description is given from the perspective of a computing device such as an air traffic management device located in an aircraft, but other configurations are possible. For instance, the method 700 could be performed by an air traffic management device located at a vertiport or another communicatively coupled device such as an air traffic management device configuration component. One of ordinary skill in the art would recognize many variations, modifications, and alternatives.

Method 700 may include block 710. At block 710, a computing device receives a message from a first air traffic management device located at a first landing area such as a vertiport by a second air traffic management device including a transceiver disposed on an aircraft, the message including information about a condition at the first landing area. For example, the second air traffic management device may be a Mode S transponder configured for ADS-B operations. The second air traffic management device may further include an ADS-B in receiver or other components. The aircraft may be an autonomous aircraft inbound for landing at the first landing area. The received message may be sent by a first air traffic management device similar to the device described in block 610 and 620 above with respect to FIG. 1.

In particular, the message may be an ADS-B message in which certain fields have been used to send information about the condition at the first landing area to the incoming autonomous aircraft. For example, for a landing area that is a vertiport, the message may include information such as vertiport FATO status, vertiport status (e.g., open or closed, operational or not, occluded by weather or not, etc.), vertiport-identifying information, vertiport weather, vertiport weather hazard data, vertiport FATO priority status or information about vertiport emergencies, vertiport terminal area operational capabilities or approach and landing operational capabilities, terminal area operational capabilities field, terminal area operational status field, or other information that may be used by incoming aircraft to determine a landing flight plan.

At block 720, responsive to the message, the computing device diverts the aircraft to a second landing area. For example, based on the information about the condition received about the first landing area condition, the autonomous aircraft may include components for receiving the information and making a determination about landing or landing location. For instance, the components may include a decision algorithm that enables the aircraft to land at the first landing area only when various criteria have been successfully determined using a C2 link or, when such a link is not available, the methods of the present disclosure to determine the landing criteria using the ADS-B message. In the event that the first landing area is determined unsafe or otherwise unsuitable for landing, the components can enable the aircraft to divert to a secondary, tertiary, etc. landing location based on suitable criteria. In some examples, the techniques of the present disclosure may again be needed to make landing determinations at the second landing area or other possible landing sites.

At block 730, the computing device broadcasts the message to one or more other aircraft, in which each of the other aircraft includes an air traffic management device configured to receive the message. For example, the ADS-B equipment on each aircraft can be used as a repeater to broadcast the information from the first landing area to other incoming autonomous aircraft before an LOS with the first landing area is established. The other aircraft can then similarly divert or otherwise modify flight plans in accordance with the information about the first landing area, in the absence of a suitable C2 link.

FIG. 8 depicts a representation of an ACARS message 800 that may be used for outputting vertiport conditions to aircraft using standardized message protocols, according to some aspects of the present disclosure. ACARS, in contrast to ADS-B, is typically used for operational and administrative messaging rather than for airspace monitoring. For example, while some air traffic management devices based on ADS-B continuously broadcast an aircraft's position, velocity, or other state vectors that ATC or other aircraft receive, ACARS may be used for transmission of discrete messages such as flight plans, weather updates, maintenance data, or landing area information.

In contrast to the structured message protocol of ADS-B, ACARS messages may include free-form text, such as alphanumeric messages using predefined message formats. Message 800 includes a header 805 and message portion 810. In this example, the message type can be identified using a predefined label field such as the 2-character alphanumeric code header 805. In this example, “XX” is used, but other headers can be used according to various examples. Message 800 further includes message body 810 including information about a hazard to landing at a vertiport and including a recommended diversionary field. Message 820 depicts another example. Message 820 includes header 825 that uses “EM,” which is used to indicate an emergency message in some ACARS implementations. Message 820 includes message body which again includes information about a hazard to landing at a vertiport and a recommended diversionary field.

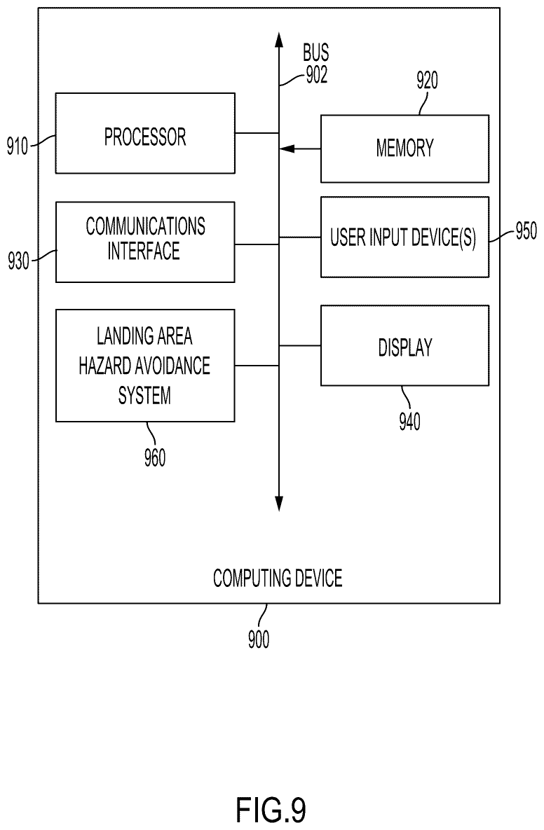

Referring now to FIG. 9, FIG. 9 shows an example computing device 900 suitable for use in example systems or methods for outputting vertiport conditions to aircraft using standardized message protocols, according to some aspects of the present disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for outputting vertiport conditions to aircraft using standardized message protocols according to different examples, such as part or all of the example methods 600, 700 described above with respect to FIGS. 6 and 7. The computing device 900, in this example, also includes one or more user input devices 950, such as a keyboard, mouse, touchscreen, microphone, etc., to accept user input. The computing device 900 also includes a display 940 to provide visual output to a user.

The computing device 900 includes a landing area hazard avoidance system 960, which may be similar in some respects to the landing area hazard avoidance system 101 of FIG. 1. The landing area hazard avoidance system 960, and its components, can use the process 910 and memory 920 to execute instructions stored on non-transitory computer-readable media to perform the methods according to this disclosure. The computing device 900 may also include components of the landing area hazard avoidance system 960, such as an air traffic management device or air traffic management device configuration component, which can be used in both ground-based or aircraft-based settings to enable sending or receiving of information relating to collision avoidance, landing hazard avoidance, weather monitoring, routine communication among various locations, including air-to-air, air-to-ground, and ground-to-ground communications, or other applications. In some examples, the computing device 900 may be a standalone component implementing certain components of the landing area hazard avoidance system 960. For instance, the computing device 900 may include components for implementing the air traffic management device or the air traffic management device configuration component as standalone devices located in ground installations or aircraft.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In the foregoing specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided above along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the above description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

That which is claimed is:

1. A method, comprising:
accessing a configuration for generating messages using a predetermined message format for a first air traffic management device located at a first landing area;
updating the configuration with information about a condition at the first landing area using the predetermined message format; and
outputting, using the first air traffic management device, a message based on the configuration, including transmitting the message to a second air traffic management device associated with an aircraft within a predetermined distance of the first landing area.

2. The method of claim 1, wherein the first air traffic management device comprises an Automatic Dependent Surveillance-Broadcast (ADS-B) receiver component and an ADS-B transmission component.

3. The method of claim 1, wherein the second air traffic management device is a Mode S transponder.

4. The method of claim 3, wherein the Mode S transponder includes an ADS-B component, the ADS-B component configured to transmit and receive ADS-B messages.

5. The method of claim 4, wherein the second air traffic management device further includes an ADS-B In receiver, the ADS-B In receiver configured to receive extended ADS-B messages.

6. The method of claim 1, wherein the predetermined message format is an ADS-B message, wherein a message type is identified using an 8-bit register identifier in one of a plurality of ADS-B message fields.

7. The method of claim 6, wherein the plurality of ADS-B message fields include at least one of a terminal area operational capabilities field or terminal area operational status field.

8. The method of claim 1, wherein the message is configured to cause the aircraft to redirect to a second landing area based on the condition.

9. The method of claim 1, wherein the aircraft is an autonomous aircraft.

10. The method of claim 1, wherein the condition is a landing hazard associated with the first landing area detected using one or more sensors or cameras provided around the first landing area.

11. The method of claim 1, wherein the aircraft does not include an operable command and control (C2) system.

12. The method of claim 1, wherein the predetermined message format is an ACARS message, wherein a message type is identified using a predefined label field comprising a 2-character alphanumeric code within an ACARS message header.

13. The method of claim 1, wherein the message is generated by a large language model (LLM) using the information about the condition at the first landing area.

14. A non-transitory computer-readable medium storing instructions that, when executed by one or more processors, cause the one or more processors to perform operations including:
accessing a configuration for generating messages using a predetermined message format for a first air traffic management device located at a first landing area;
updating the configuration with information about a condition at the first landing area using the predetermined message format; and
outputting, using the first air traffic management device, a message based on the configuration, including transmitting the message to a second air traffic management device associated with an aircraft within a predetermined distance of the first landing area.

15. The non-transitory computer-readable medium of claim 14, wherein:
the first air traffic management device comprises an ADS-B receiver component and an ADS-B transmission component; and
the second air traffic management device is a Mode S transponder.

16. The non-transitory computer-readable medium of claim 14, wherein the predetermined message format is an ADS-B message, wherein a message type is identified using an 8-bit register identifier in one of a plurality of ADS-B message fields.

17. The non-transitory computer-readable medium of claim 14, wherein:
the condition is a landing hazard associated with the first landing area detected using one or more sensors or cameras provided around the first landing area; and
the message is configured to cause the aircraft to redirect to a second landing area based on the condition.

18. A system comprising:
one or more processors; and
one or more computer-readable storage media storing instructions which, when executed by the one or more processors, cause the one or more processors to perform operations including:
accessing a configuration for generating messages using a predetermined message format for a first air traffic management device located at a first landing area;
updating the configuration with information about a condition at the first landing area using the predetermined message format; and
outputting, using the first air traffic management device, a message based on the configuration, including transmitting the message to a second air traffic management device associated with an aircraft within a predetermined distance of the first landing area.

19. The system of claim 18, wherein:
the first air traffic management device comprises an ADS-B receiver component and an ADS-B transmission component; and
the second air traffic management device is a Mode S transponder.

20. The system of claim 18, wherein the predetermined message format is an ADS-B message, wherein a message type is identified using an 8-bit register identifier in one of a plurality of ADS-B message fields.
